(19) United States
(12) Patent Application Publication
(10) Pub. No.: US 2024/0121691 A1
(43) Pub. Date: Apr. 11, 2024

(54) JOINT SCELL AND PCELL ACTIVATION/DEACTIVATION SIGNALING IN L1/L2 INTER-CELL MOBILITY

(71) Applicant: QUALCOMM Incorporated, San Diego, CA (US)

(72) Inventors: Shanyu ZHOU, San Diego, CA (US); Jelena DAMNJANOVIC, Del Mar, CA (US)

(21) Appl. No.: 18/045,458

(22) Filed: Oct. 10, 2022

(51) Int. Cl. H04W 36/32; H04W 36/00

(52) U.S. Cl. CPC H04W 36/32; H04W 36/0061

(57) ABSTRACT

A method for wireless communication at a user equipment (UE) and related apparatus are provided. In the method, the UE receives from a network entity a configuration for layer 1 (L1) or layer 2 (L2) mobility cell for a set of cells that are able to be activated or deactivated for data or control transmission using L1 or L2 signaling. The configuration includes at least one cell that supports L1 or L2 activation as a special cell (SpCell). The UE further receives from the network entity L1 or L2 signaling for one or more configured cells or one or more configured groups of cells in the set of cells carrying information about activation, deactivation, or update of the SpCell, or update of a group of cells with SpCell, and communicates via one or more activated cells in the set of cells based on the L1 or L2 signaling.

### TECHNICAL FIELD

The present disclosure relates generally to communication systems, and more particularly, to wireless communication with joint secondary cell (SCell) and primary cell (PCell) activation/deactivation signaling in L1/L2 inter-cell mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory; and at least one processor coupled to the memory and configured to receive, from a network entity, a configuration for layer 1 (L1) or layer 2 (L2) mobility cell for a set of cells that are able to be activated or deactivated for data or control transmission using L1 or L2 signaling. The configuration includes at least one cell that supports L1 or L2 activation as a special cell (SpCell). The at least one processor is further configured to receive, from the network entity, L1 or L2 signaling for one or more configured cells or one or more configured groups of cells in the set of cells carrying information about activation, deactivation, or update of the SpCell, or update of a group of cells with SpCell; and communicate via one or more activated cells in the set of cells based on the L1 or L2 signaling.

In an aspect of the disclosure, a method, a computer-readable medium, and an apparatus are provided for wireless communication at a network entity. The apparatus may include memory; and at least one processor coupled to the memory and configured to transmit, to a UE, a configuration for L1 or L2 mobility cell for a set of cells that are able to be activated or deactivated for data or control transmission using L1 or L2 signaling. The configuration may include at least one cell that supports L1 or L2 activation as an SpCell. The at least one processor is further configured to transmit, to the UE, L1 or L2 signaling for one or more configured cells or one or more configured groups of cells in the set of cells carrying information about activation, deactivation, or update of the SpCell, or update of a group of cells with SpCell; and communicate with the UE via one or more activated cells in the set of cells based on the L1 or L2 signaling.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a diagram illustrating example beam management.

FIG. 4B is a diagram illustrating example inter-cell beam management.

FIG. 5 is a diagram illustrating an example cell configuration.

FIG. 6 is a diagram illustrating a system model of an example cell configuration.

FIGS. 7A and 7B are diagrams illustrating example messages for L1/L2 cell activation/deactivation in accordance with various aspects of the present disclosure.

FIG. 8 is a call flow diagram illustrating a method of wireless communication in accordance with various aspects of the present disclosure.

FIG. 9 is the first flowchart illustrating methods of wireless communication at a UE in accordance with various aspects of the present disclosure.

FIG. 10 is the first flowchart illustrating methods of wireless communication at a network entity in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

A UE may receive a configuration of cells that may be activated for layer 1 (L1) or layer 2 (L2) inter-cell mobility. From the cells configured for L1/L2 inter-cell mobility, the UE may receive control signaling activating one or more cells. Mobility within the configured set of cells may be performed through L1/L2 signaling that allows a quicker activation and deactivation of particular cells in the configured set of cells, e.g., than L3 signaling. Aspects presented herein enable joint cell activation/deactivation in secondary cells (SCells) and a special cell (SpCell) such as a primary cell (PCell). As presented herein, a user equipment may receive, from a network entity, a configuration for L1/L2 mobility cell for a set of cells that are able to be activated or deactivated for data or control transmission using L1 or L2 signaling. The configuration may include at least one cell that supports L1 or L2 activation as an SpCell. The UE may further receive, from the network entity, L1 or L2 signaling for one or more SCells in the set of cells carrying information about activation, deactivation, or update of the SpCell, or update of a group of cells with SpCell; and communicate via one or more activated cells in the set of cells based on the L1 or L2 signaling. The joint cell activation/deactivation facilitates fast and efficient L1/L2 mobility, and improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

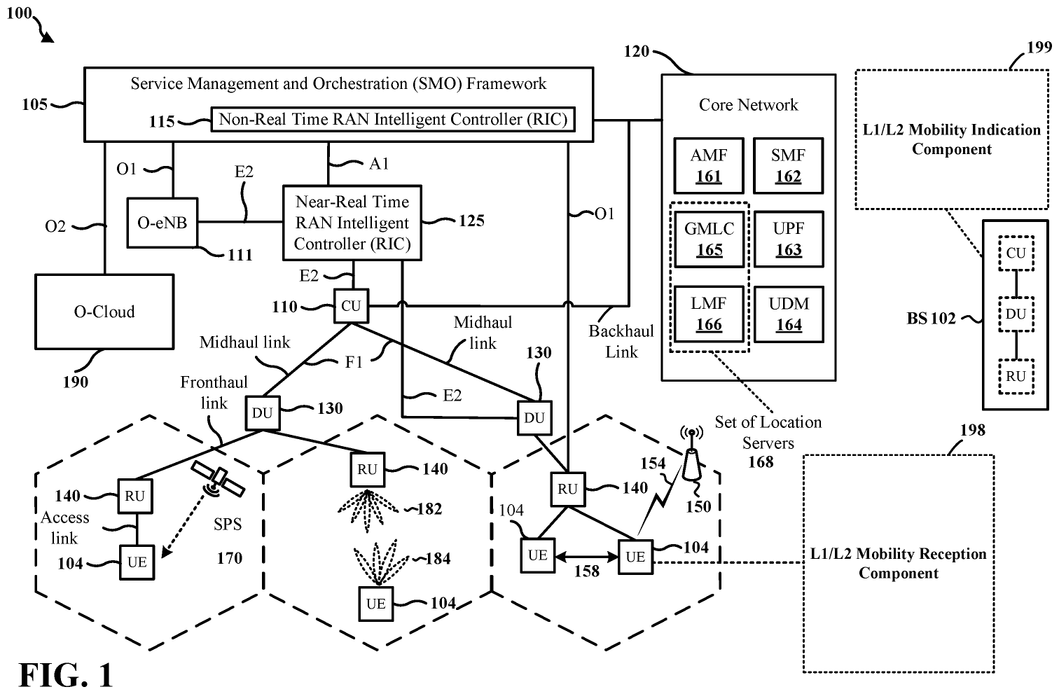

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an L1/L2 mobility reception component 198. The L1/L2 mobility reception component 198 may be configured to receive, from a network entity, a configuration for L1 or L2 mobility cell for a set of cells that are able to be activated or deactivated for data or control transmission using L1 or L2 signaling. The configuration may include at least one cell that supports L1 or L2 activation as an SpCell. The L1/L2 mobility reception component 198 may be further configured to receive, from the network entity, L1 or L2 signaling for one or more configured cells or one or more configured groups of cells in the set of cells carrying information about activation, deactivation, or update of the SpCell, or update of a group of cells with SpCell; and communicate via one or more activated cells in the set of cells based on the L1 or L2 signaling. In certain aspects, the base station 102 may include an L1/L2 mobility indication component 199. The L1/L2 mobility indication component 199 may be configured to transmit, to a UE, a configuration for L1 or L2 mobility cell for a set of cells that are able to be activated or deactivated for data or control transmission using L1 or L2 signaling. The configuration may include at least one cell that supports L1 or L2 activation as an SpCell. The L1/L2 mobility indication component 199 may be further configured to transmit, to the UE, L1 or L2 signaling for one or more configured cells or one or more configured groups of cells in the set of cells carrying information about activation, deactivation, or update of the SpCell, or update of a group of cells with SpCell; and communicate with the UE via one or more activated cells in the set of cells based on the L1 or L2 signaling. Although the following description may be focused on 5G NR, the concepts described herein may be applicable to other similar areas, such as LTE, LTE-A, CDMA, GSM, and other wireless technologies.

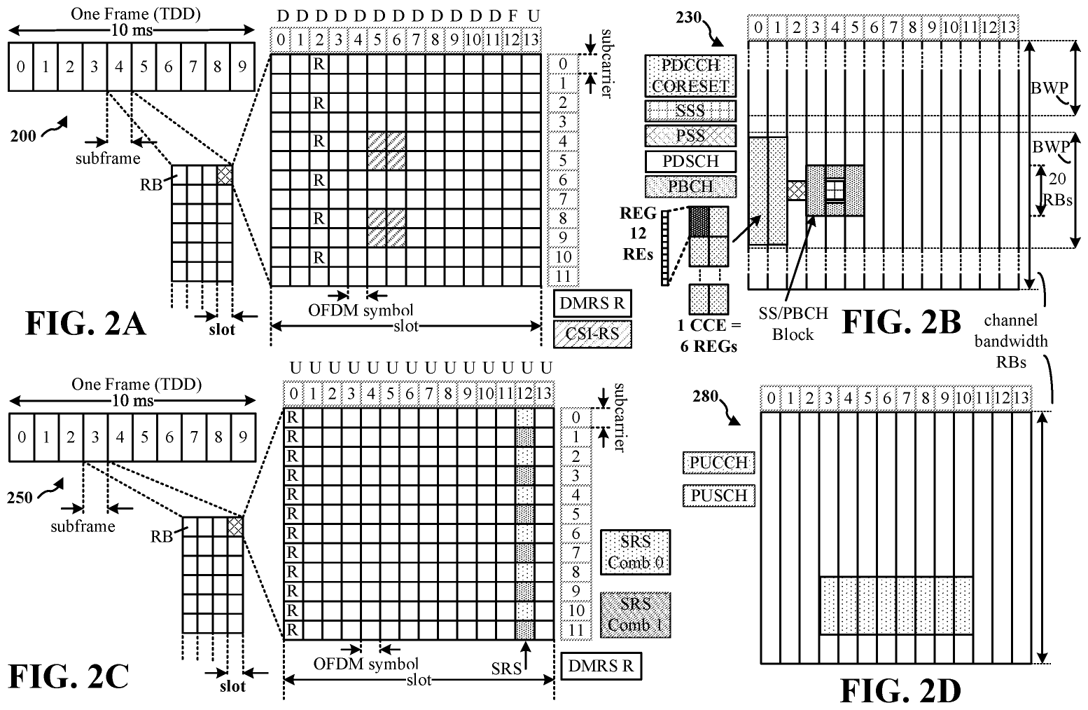

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIB s), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

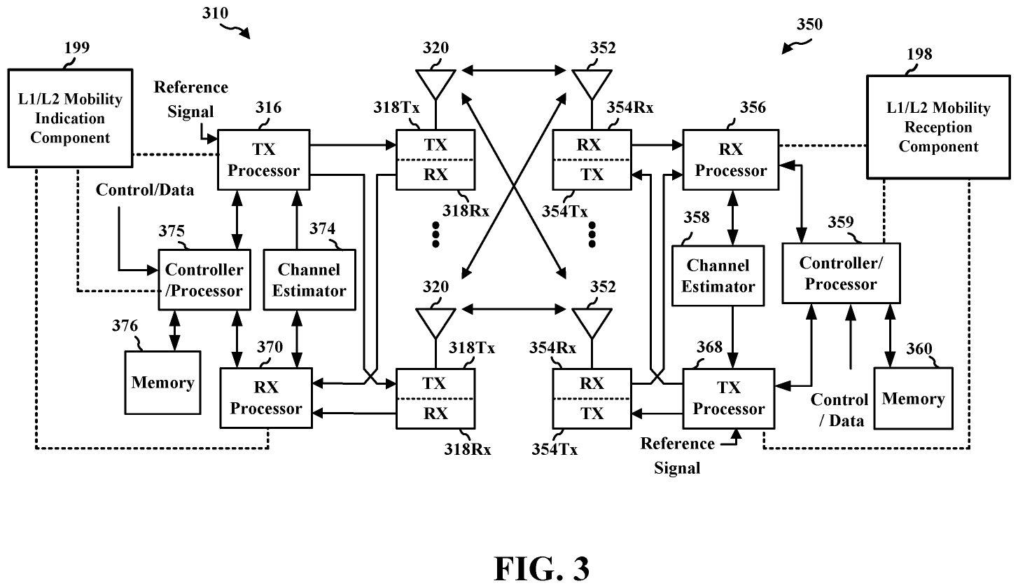

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the L1/L2 mobility reception component 198 of FIG. 1.

At least one of the TX processor 316, the RX processor 370, and the controller/processor 375 may be configured to perform aspects in connection with the L1/L2 mobility indication component 199 of FIG. 1.

A network may communicate with a UE based on one or more beams (spatial filters). For example, a base station of the network may transmit a beamformed signal to a UE in one or more directions that correspond with one or more beams. The base station and the UE may perform beam training to determine the best receive and transmit directions for the base station and the UE.

In response to different conditions, beams may be switched. For example, a transmission configuration indication (TCI) state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi co-location (QCL) information that the UE can use to derive timing/frequency error and/or transmission/reception spatial filtering for transmitting/receiving a signal.

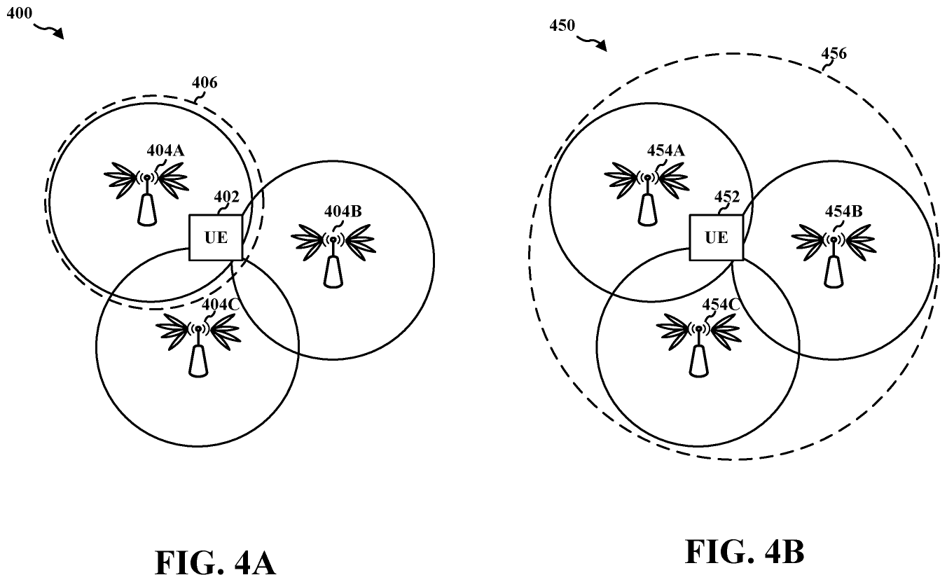

Different procedures for managing and controlling beams for wireless communication may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. FIG. 4A is a diagram 400 illustrating example beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP.

By way of example, a UE may encounter two types of mobility—cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 4B is a diagram 450 illustrating example inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

As an example, inter-cell beam management based on beam-based mobility may be facilitated by L1 and/or L2 signaling such as UE-dedicated channels/RSs which may be associated with a switch to a TRP with different PCI according to downlink control information (DCI) or medium access control (MAC) control element (MAC-CE) based unified TCI update. As used herein, such mobility may be referred to as L1/L2 mobility.

In some aspects, the network may configure a set of cells for L1/L2 mobility. The set of cells for L1/L2 mobility may be referred to as L1/L2 mobility configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set). The subset of cells in the L1/L2 mobility configured cell set that are not activated or that are indicated to be deactivated may be referred to as an L1/L2 mobility deactivated cell set or a deactivated L1/L2 mobility cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that are configured for the UE yet deactivated (e.g. not used for data/control transfer until activated) and may be activated by L1/L2 signaling. Once activated, a deactivated cell may be used for data and control transfer between a UE and a base station. The L1/L2 inter-cell mobility may reduce mobility latency. The configuration and maintenance of multiple candidate cells may allow for a quicker application of configurations for the candidate cells, and the activated set of cells may provide for dynamic switching among the candidate serving cells (e.g., including an SpCell and SCell) based on L1 or L2 signaling.

The procedures of L1/L2 based inter-cell mobility are applicable to many scenarios. These scenarios may include, but not limited to, standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements such as one or more of an RSRP, an RSRQ, a received signal strength indicator (RSSI), or a signal to noise and interference ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

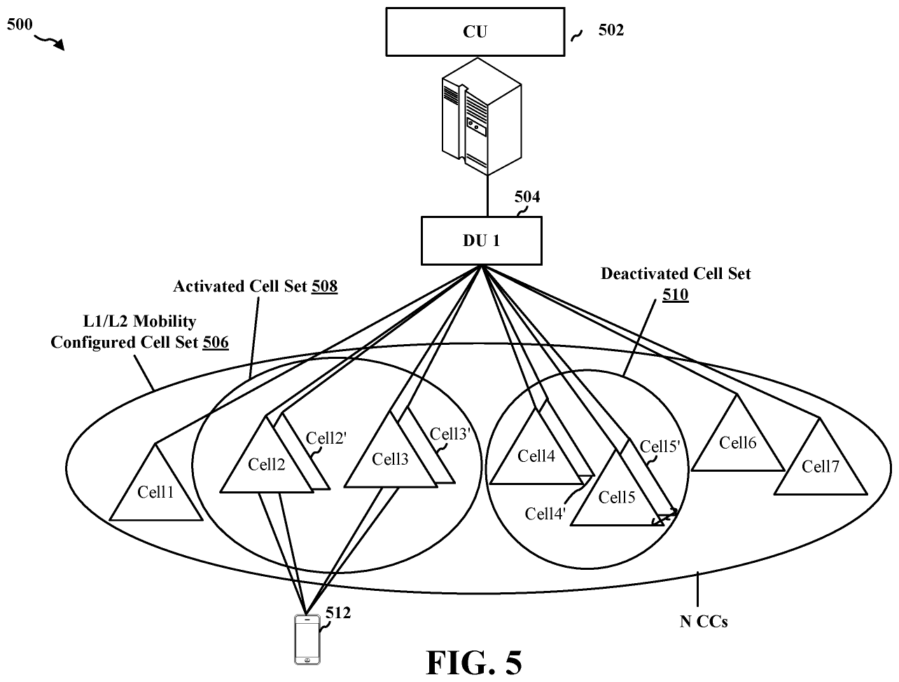

FIG. 5 is a diagram 500 illustrating an example cell configuration. As illustrated in FIG. 5, a CU 502 (which may correspond to a component of a base station such as a gNB) may be associated with a first DU 504 (and other DUs). An L1/L2 mobility configured cell set 506 may be associated with the first DU 504 and may include an L1/L2 mobility activated cell set 508 and an L1/L2 mobility deactivated cell set 510. The L1/L2 mobility configured cell set 506 may also include one or more cells not in the current L1/L2 mobility activated cell set 508 or the current L1/L2 mobility deactivated cell set 510. For example, at a given time, the L1/L2 mobility activated cell set 508 may include a first subset of cells in the L1/L2 mobility configured cell set, and the L1/L2 mobility deactivated cell set 510 may include a second, non-overlapping subset of cells in the L1/L2 mobility configured cell set. There may remain one or more cells that are in the L1/L2 mobility configured cell set that are not in the first set subset (e.g., activated) or the second subset (e.g., deactivated). A UE 512 may use the cells in the L1/L2 mobility activated cell set 508 for data channel and control channel communications.

A UE may be configured with a set of cells for L1/L2 mobility under the carrier aggregation (CA) framework. The set of the cells for L1/L2 mobility may be RRC configured and may include a single PCell and multiple SCells at a given time. The SCells may be updated as a PCell, e.g., changed to a PCell configuration or activated as a PCell, using L1/L2 signaling, and the PCell may be updated as, e.g., changed to, an SCell using L1/L2 signaling. For example, a cell may switch between acting as a PCell and an SCell for the UE.

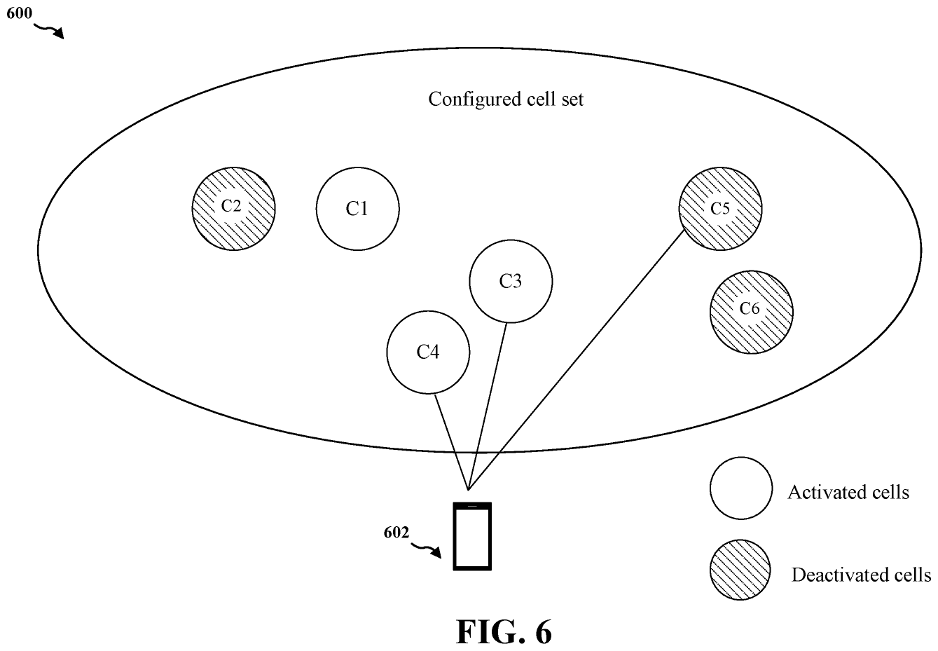

FIG. 6 is a diagram 600 illustrating a system model of an example cell configuration. As shown in FIG. 6, a UE 602 may be configured with a set of cells (C1, . . . , C6) for L1/L2 mobility. The set of cells, e.g., for L1/L2 inter-cell mobility, may be configured through RRC signaling. Cells in the configured set (including cells configured to act as a PCell and cells configured to act as SCells) may be further characterized into two groups: activated cells and deactivated cells, as shown in FIG. 6. The activated cells are serving cells that are currently active and can be used for data and control transfer between the network and the UE. The deactivated cells are cells that are currently deactivated (and hence have no active data or control communication with the UE 602) but can be quickly activated through L1/L2 signaling to the UE from the network. The UE may exchange, or monitor for, data and control communication with the base station on activated cells, and the UE may perform L1 measurement on all cells in the L1/L2 configured cell set (including both activated and deactivated cells).

In CA, the SCell may be activated by a MAC-CE. A PCell may be changed using L3 signaling. This disclosure presents a joint cell activation/deactivation message for SCell and PCell updates in L1/L2 mobility. The joint cell activation/deactivation facilitates fast and efficient L1/L2 mobility and potentially may include additional configuration selection for activated SCell and PCell. Additionally, the present disclosure further presents multiple options for joint MAC-CE and/or DCI design.

In some aspects of the present disclosure, cells in an L1/L2 mobility configured set may be controlled (e.g., activated and deactivated) by L1/L2 mobility signaling that conveys cell activation/deactivation and PCell activation/deactivation (in a single joint message). Joint L1/L2 signaling that contains an SCell activation/deactivation and PCell activation/deactivation command allows for simultaneous cell activation and designation as a PCell and simultaneous deactivation and PCell re-designation of a cell. If there is no PCell change and only SCell activation/deactivation is indicated, a MAC-CE for activation/deactivation of an SCell can be transmitted. As presented herein, the MAC-CE may include or an indication in the joint message indicating that there is no PCell change. The joint L1/L2 signaling may be implemented in a DCI format or a MAC-CE format. The DCI format or MAC-CE format may include a Logical Channel ID (LCID) or an eLCID for L1/L2 mobility cell activation/deactivation including SCell and PCell activation. The MAC-CE format or the DCI format may include one or more of: a pointer to the cell ID being activated/deactivated or setting the bit in the bitmap corresponding to the cell ID, a field indicating whether the cell is activated as the new PCell, a pointer to parameter spCellConfig (a PCell configuration) to be activated if multiple configurations are available for the cell or setting the bit in the bitmap corresponding to one of the available PCell configurations, TCI state(s) to be activated for each activated cell, an RS for beam refinement, and an RS ID to use for L1 reporting of the cells being deactivated (may be provided when cells are toggled or may be always provided). Cells that are not configured for L1/L2 mobility may be controlled by a CA activation/deactivation MAC-CE, e.g., rather than an L1/L2 mobility MAC-CE.

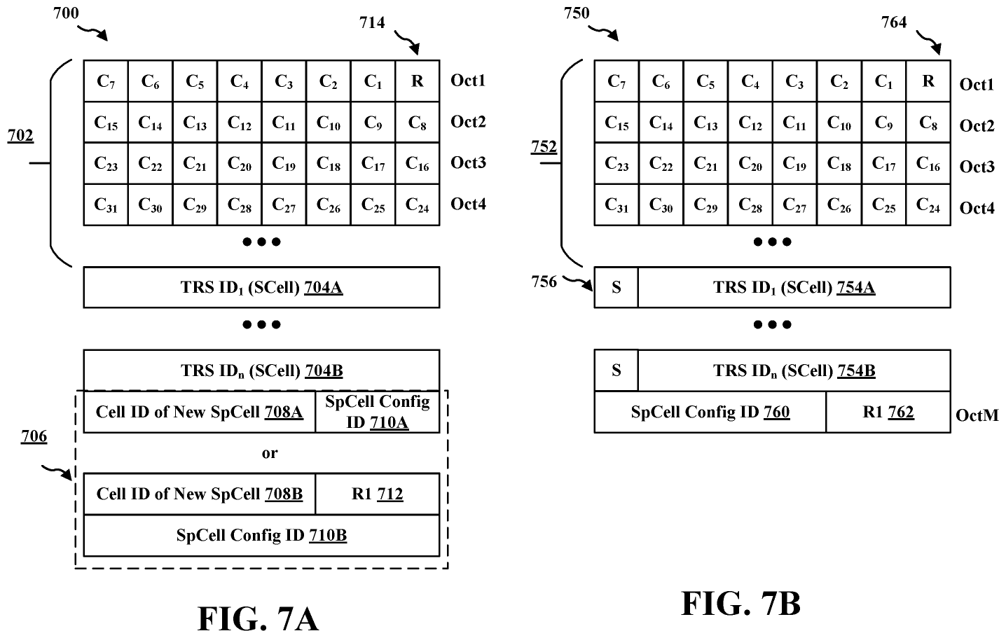

FIG. 7A is a diagram illustrating an example message 700 for L1/L2 cell activation/deactivation in accordance with various aspects of the present disclosure.

The example message may be a MAC-CE for L1/L2 mobility.

As shown in FIG. 7A, the MAC-CE may include a bit map (C field) 702. The C field 702 may be a field of binary bits, in which 0 refers to the deactivated cell index, and 1 refers to the activated cell index. As shown in FIG. 7A, the C field 702 may represent the multiple activated cells and deactivated cells at one time. Out of all the activated cells, one cell may be designated to be a new SpCell. For example, C₁ may refer to a first configured cell for L 1/L2 inter-cell mobility, C₂ may refer to a second cell configured for L1/L2 inter-cell mobility, C₃ may refer to a third cell configured for L1/L2 inter-cell mobility, and so forth up to C₃₁, in the example in FIG. 7A. The bit value (e.g., 0 or 1) for C₁, C₂, C₃, . . . and C₃₁, may indicate whether the corresponding cell is activated or deactivated for L1/L2 inter-cell mobility. The C field 702 may include multiple octets (i.e., multiple eight-bit groups), such as Oct1, Oct2, etc., as shown in FIG. 7A. The number of octets designated to reference the cells configured for L1/L2 mobility may correspond to the maximum number of cells that can be configured for L1/L2 mobility, the overall number of configured cells, or the maximum number of cells that can be configured for a UE.

As shown in FIG. 7A, for each of the currently activated cells (cell subset of size n) that were previously deactivated, there may be a tracking reference signal (TRS) ID (e.g., 8-bit TRS IDs 704A, 704B) pointing to an RRC configuration for an SCell activation reference signal configuration (which may be referred to as “SCellActivationRS-Config” or “SCellActivationRS-Config-r17” as an example). If there is an SpCell update, extra octet(s) 706 of information may be attached for the updated SpCell. The extra octet(s) 706 may include cell ID 708A, 708B of the new SpCell and the SpCell configuration ID 710A, 710B that points to a specific SpCell RRC configuration if multiple SpCell configurations are configured for the UE. In one configuration, the cell ID 708A of the new SpCell and the SpCell configuration ID 710A may occupy the same octet. Alternatively, the cell ID 708B of the new SpCell and the new SpCell configuration ID 710B may occupy separate octets, with zero or more reserved bits R1 712.

Referring to FIG. 7A, in one configuration, the reserved bit R 714 in the octet Oct1 may be used to indicate whether this MAC-CE carries an SpCell update (set to 1) or not (set to 0). The reserved bit R 714 may imply whether the octet(s) referring to the SpCell info is(are) present or not. If there is an SpCell update, the current SpCell may be assumed activated upon becoming an SCell. Additional bit may be used to indicate the activation/deactivation of the current SpCell. In another configuration, the reserved bit R 714 in the octet Oct1 may indicate the new status (i.e., activated/deactivated) of the cell that is currently the SpCell if there is an SpCell update. Setting the reserved bit R 714 to 0 (current SpCell being deactivated) implies an SpCell update. Setting the reserved bit R 714 to 1 indicates there may or may not be an SpCell update. An additional bit may be used to indicate whether there is an SpCell update. Alternatively, a special bit setting for the SpCell update field may be defined to indicate whether there is an SpCell update.

FIG. 7B is a diagram illustrating another example message 750 for L1/L2 cell activation/deactivation in accordance with various aspects of the present disclosure. The example message may be a MAC-CE for L1/L2 mobility.

As shown in FIG. 7B, the MAC-CE may include a bit map (C field) 752. The C field 752 may be a field of binary bits, in which 0 refers to the deactivated cell index, and 1 refers to the activated cell index. As shown in FIG. 7B, the C field 752 may represent the multiple activated cells and deactivated cells at one time. Out of all the activated cells, one cell may be designated to be a new SpCell. For example, C₁ may refer to a first configured cell for L1/L2 inter-cell mobility, C₂ may refer to a second cell configured for L1/L2 inter-cell mobility, C₃ may refer to a third cell configured for L1/L2 inter-cell mobility, and so forth up to C₃₁, in the example in FIG. 7B. The bit value (e.g., 0 or 1) for C₁, C₂, C₃, . . . and C₃₁, may indicate whether the corresponding cell is activated or deactivated for L1/L2 inter-cell mobility. The C field 752 may include multiple octets (i.e., multiple eight-bit groups), such as Oct1, Oct2, etc., as shown in FIG. 7B. The number of octets designated to reference the cells configured for L1/L2 mobility may correspond to the maximum number of cells that can be configured for L1/L2 mobility, the overall number of configured cells, or the maximum number of cells that can be configured for a UE.

As shown in FIG. 7B, for each of the currently activated cells (cell subset of size n) that were previously deactivated, there may be a 7-bits TRS ID (e.g., 7-bit TRS IDs 754A, 754B) pointing to an RRC configuration for an SCell activation reference signal configuration (which may be referred to as “SCellActivationRS-Config” or “SCellActivationRS-Config-r17” as an example). The first bits of the octet where the TRS ID is indicated may be a one-bit field S 756. The one-bit field S 756 may indicate if there is an SpCell update. That is, if the cell is an SpCell, the one-bit field S 756 may be set to 1. If the cell is an SCell, the one-bit field S 756 may be set to 0. When the one-bit field S 756 is set to 0, the remaining 7 bits may refer to the TRS ID that points to an RRC configuration for an SCell activation reference signal configuration (e.g., “SCellActivationRS-Config” or “SCellActivationRS-Config-r17”) for the SCell to use upon activation. When the one-bit field S 756 is set to 1, the remaining 7 bits for the SpCell may refer to the TRS ID that points to the configuration for the SpCell to use upon activation.

There may be additional octet(s) for additional info for the SpCell. For the updated SpCell, an extra octet of information may be designated for SpCell configuration ID that points to a specific SpCell RRC configuration if multiple SpCell configurations are configured for the UE. The SpCell configuration ID may occupy a full octet or a part of an octet with one or more reserved bits, and the extract octet is present if there is an SpCell update. For example, referring to FIG. 7B, The SpCell configuration ID 760 occupies a part of an octet with one or more reserved bits R1 762.

In some aspects, the reserved bit R 764 in the Oct 1 may be used to indicate the new status (i.e., activated/deactivated) of the cell that is currently the SpCell in case there is an SpCell update.

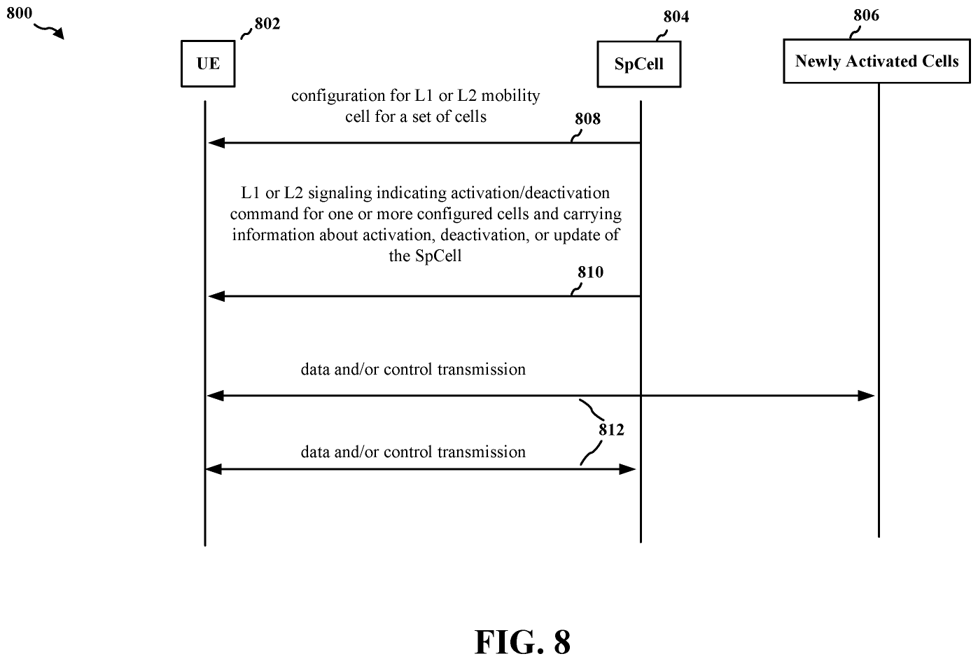

FIG. 8 is a call flow diagram 800 illustrating a method of wireless communication in accordance with various aspects of this present disclosure. The call flow diagram 800 illustrates joint timing SCell and PCell activation/deactivation signaling in L1/L2 inter-cell mobility. As shown in FIG. 8, at 808, a UE 802 may receive, from a SpCell 804, a configuration for L1 or L2 mobility cell for a set of cells that are able to be activated or deactivated for data or control transmission using L1 or L2 signaling. The configuration may include at least one cell that supports L1 or L2 activation as an SpCell. At 810, the UE 802 may receive, from the SpCell 804, L1 or L2 signaling for one or more configured cells or one or more configured groups of cells in the set of cells. The L1 or L2 signaling may carry information about activation, deactivation, or update of the SpCell, or update of a group of cells with SpCell. In one configuration, the L1 or L2 signaling may indicate activation/deactivation command for one or more configured cells or one or more configured groups of cells in the set of cells. Each configured group of cells may be defined by RRC configuration. The configured cells or configured groups of cells may be SCells in the set of cells, and the L1 or L2 signaling may include any of the aspects described in connection with FIGS. 4A, 4B, 5, 6. 7A, and 7B, for example. At 812, the UE 802 may communicate via one or more activated cells in the set of cells based on the L1 or L2 signaling. The one or more activated cells may include the SpCell 804 and any newly activated cells 806. The communication between the UE 802 and the one or more activated cells 806 may include one or more of data transmission or control transmission between the UE 802 and the one or more activated cells 806.

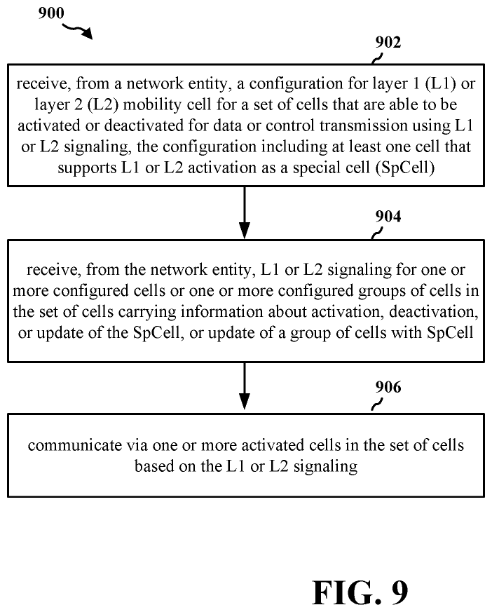

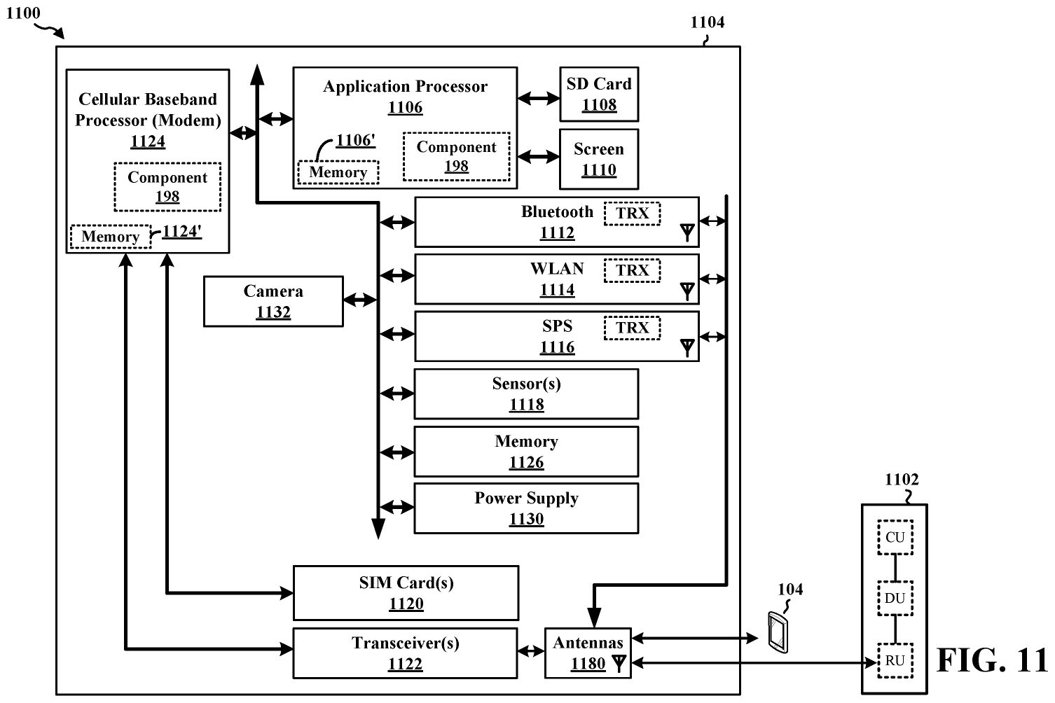

FIG. 9 is a flowchart 900 illustrating methods of wireless communication at a UE in accordance with various aspects of the present disclosure. The method may be performed by a UE. The UE may be the UE 104, 350, 802, or the apparatus 1104 in the hardware implementation of FIG. 11. The method enables joint cell activation/deactivation in SCell and PCell to facilitate fast and efficient L1/L2 mobility. Thus, it improves the efficiency of wireless communication.

As shown in FIG. 9, at 902, the UE may receive, from a network entity, a configuration for L1 or L2 mobility cell for a set of cells that are able to be activated or deactivated for data or control transmission using L1 or L2 signaling. The configuration may include at least one cell that supports L1 or L2 activation as an SpCell. The network entity may be a base station, or a component of a base station, in the access network of FIG. 1 or a core network component (e.g., base station 102, 310; SpCell 804; or the network entity 1102 in the hardware implementation of FIG. 11). FIGS. 7A, 7B, and 8 illustrate various aspects of the steps in connection with flowchart 900. For example, referring to FIG. 8, the UE 802 may receive, at 808, from a network entity (SpCell 804), a configuration for L1 or L2 mobility cell for a set of cells that are able to be activated or deactivated for data or control transmission using L1 or L2 signaling. In this specification, the “data or control transmission” refers to the transmission of data, or control, or both data and control.

At 904, the UE may receive, from the network entity, L1 or L2 signaling for one or more configured cells or one or more configured groups of cells in the set of cells. The L1 or L2 signaling may carry information about activation, deactivation, or update of the SpCell, or update of a group of cells with SpCell. In one configuration, the configured cells or configured groups of cells may be SCells in the set of cells. In one configuration, the L1 or L2 signaling may indicate activation/deactivation command for the one or more configured cells or the one or more configured groups of cells in the set of cells. Each configured group of cells may be defined by RRC configuration. For example, referring to FIG. 8, the UE 802 may receive, at 810, from the network entity (SpCell 804), L1 or L2 signaling indicating activation/deactivation command for one or more configured cells in the set of cells and carrying information about activation, deactivation, or update of the SpCell, or update of a group of cells with SpCell.

At 906, the UE may communicate via one or more activated cells in the set of cells based on the L1 or L2 signaling. For example, referring to FIG. 8, the UE 802 may, at 812, communicate via one or more activated cells (e.g., 804, 806) in the set of cells based on the L1 or L2 signaling the UE 802 receives at 810.

In some aspects, the L1 or L2 signaling may be received through a MAC-CE or DCI. For example, referring to FIG. 8, when the UE 802 receives, at 810, from the network entity (SpCell 804), the L1 or L2 signaling, the L1 or L2 signaling may be received through a MAC-CE or DCI.

In some aspects, the information about the activation or the deactivation of the SpCell may indicate a current SpCell is unchanged. In some aspects, the information about the activation or the deactivation of the SpCell may activate a different SpCell. For example, referring to FIG. 8, in one example, the L1 or L2 signaling the UE 802 receives, at 810, may carry information that indicates a current SpCell 804 is unchanged. In another example, the L1 or L2 signaling the UE 802 receives, at 810, may carry information that activates a different SpCell than the SpCell 804.

In some aspects, the L1 or L2 signaling may include one or more of: an ID pointer to a cell ID of a cell in the set of cells being activated or deactivated; ID information corresponding to the cell ID; a field indicating whether the cell is activated as a new SpCell; a configuration pointer to an SpCell configuration of multiple previously configured SpCell configurations; SpCell configuration information corresponding to the SpCell configuration of the multiple previously configured SpCell configurations; a TCI state to activate for each activated cell in the set of cells; an RS for beam refinement; and an RS ID to use for L1 reporting of the cells being deactivated in the set of cells. In one example, referring to FIGS. 7A and 7B, the ID information corresponding to a cell ID may be an ID bit (C₁, C₂, C₃, . . . C₃₁ in FIGS. 7A and 7B) in a bit map 702, 752. The SpCell configuration information may be a bit (e.g., an SpCell configuration ID 710A, 710B, 760) in the bit map corresponding to the SpCell configuration of the multiple previously configured SpCell configurations.

In some aspects, the L1 or L2 signaling may be received through a message in the MAC-CE, and the message may include one or more of: activation information indicating activated cells and deactivated cells in the set of cells, a TRS ID for each of the activated cells that were deactivated, a cell ID for a new SpCell in the set of cells, and an SpCell configuration ID for an SpCell configuration of multiple SpCell configurations for the new SpCell. For example, referring to FIGS. 7A, 7B, 8, the activation information may be a bitmap 702, 752 indicating activated cells and deactivated cells in the set of cells. The message the UE 802 receives, at 810, may include one or more of: a bitmap 702, 752 indicating activated cells and deactivated cells in the set of cells, a TRS ID 704A, 704B, 754A, 754B for each of the activated cells that were deactivated, a cell ID 708A, 708B for a new SpCell in the set of cells, and an SpCell configuration ID 710A, 710B, 760 for an SpCell configuration of multiple SpCell configurations for the new SpCell.

In some aspects, the message may include a number of octets corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE. For example, referring to FIGS. 7A, 7B, and 8, the UE 802 may receive from the network entity (SpCell 804), at 810, the L1 or L2 signaling through a message 700, 750 in the MAC-CE, and the message 700, 750 may include a number of octets Oct1, Oct2, Oct3, . . . corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE 802.

In some aspects, the message may include the cell ID for the new SpCell in the set of cells and the SpCell configuration ID, and the cell ID and the SpCell configuration ID may occupy a separate octet with zero or more reserved bits. For example, referring to FIGS. 7A and 7B, the message 700, 750 may include the cell ID 708A, 708B for the new SpCell in the set of cells and the SpCell configuration ID 710A, 710B, 760, and the cell ID 708A, 708B and the SpCell configuration ID 710A, 710B, 760 may occupy a separate octet with zero or more reserved bits 712, 762.

In some aspects, a first octet of the number of octets may include a reserved bit, and the reserved bit may be configured to indicate one or more of: whether the MAC-CE carries an SpCell update; and a new status of a current SpCell in the set of cells. For example, referring to FIGS. 7A and 7B, the first octet Oct1 of the number of octets may include a reserved bit R 714, 764. The reserved bit R 714, 764 may be configured to indicate one or more of: whether the MAC-CE carries an SpCell update; and a new status of a current SpCell in the set of cells.

In some aspects, an oct corresponding to the TRS ID may include an 8-bit TRS ID pointing to an SCell configuration for the SCells activated by the L1 or L2 signaling. For example, referring to FIGS. 7A and 8, an octet corresponding to the TRS ID may include an 8-bit TRS ID 704A, 704B pointing to an SCell configuration for the SCells activated by the L1 or L2 signaling the UE 802 receives at 810.

In some aspects, an octet corresponding to the TRS ID may include a 7-bit TRS ID and a one-bit status field indicating whether there is an SpCell update. For example, referring to FIG. 7B, an octet corresponding the TRS ID may include a 7-bit TRS ID 754A, 754B and a one-bit status field S 756 indicating whether there is an SpCell update.

In some aspects, when the one-bit status field is 0, the 7-bit TRS ID may point to an SCell configuration for the SCells activated by the L1 or L2 signaling. When the one-bit status field is 1, the 7-bit TRS ID may point to the SpCell configuration for the SpCell activated by the L1 or L2 signaling. For example, referring to FIGS. 7B and 8, when the one-bit status field S 756 is 0, the 7-bit TRS ID 754A may point to an SCell configuration for the SCells activated by the L1 or L2 signaling the UE 802 receives at 810. When the one-bit status field S 756 is 1, the 7-bit TRS ID 754A may point to the SpCell configuration for the SpCell activated by the L1 or L2 signaling the UE 802 receives at 810.

In some aspects, the one-bit status field may be 1, and the message may further include one or more additional octets for additional information for the SpCell. In some aspects, the one or more additional octets may include the SpCell configuration ID for the SpCell configuration of the multiple SpCell configurations. For example, referring to FIG. 7B, the one-bit status field S may be 1, and the message 750 may further include one or more additional octets OctM for additional information for the SpCell. The one or more additional octets OctM may include the SpCell configuration ID 760 for the SpCell configuration of the multiple SpCell configurations.

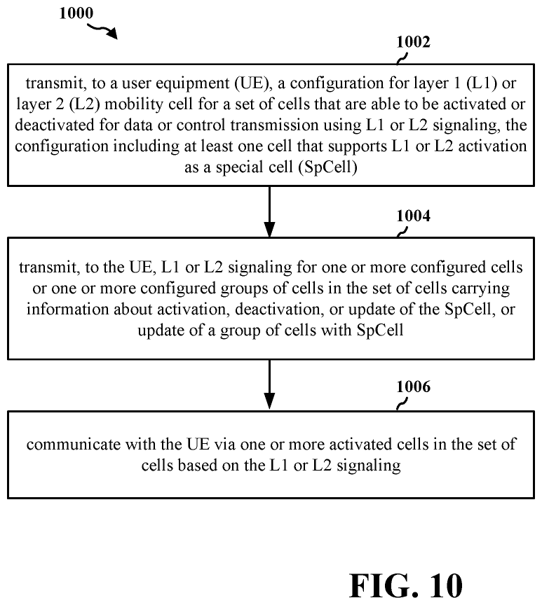

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310; SpCell 804; or the network entity 1102 in the hardware implementation of FIG. 11). The method enables joint cell activation/deactivation in SCell and PCell to facilitate fast and efficient L1/L2 mobility. Thus, it improves the efficiency of wireless communication.

As shown in FIG. 10, at 1002, the network entity may transmit, to a UE, a configuration for L1 or L2 mobility cell for a set of cells that are able to be activated or deactivated for data or control transmission using L1 or L2 signaling. The configuration may include at least one cell that supports L1 or L2 activation as an SpCell. The UE may be the UE 104, 350, 802, or the apparatus 1104 in the hardware implementation of FIG. 11. FIGS. 7A, 7B, and 8 illustrate various aspects of the steps in connection with flowchart 1000. For example, referring to FIG. 8, the network entity (SpCell 804) may transmit, at 808, to a UE 802, a configuration for L1 or L2 mobility cell for a set of cells that are able to be activated or deactivated for data or control transmission using L1 or L2 signaling. The configuration may include at least one cell that supports L1 or L2 activation as an SpCell.

At 1004, the network entity may transmit, to the UE, L1 or L2 signaling indicating an activation/deactivation command for one or more configured cells or one or more configured groups of cells in the set of cells. The L1 or L2 signaling may carry information about activation, deactivation, or update of the SpCell, or update of a group of cells with SpCell. In one configuration, the configured cells or configured groups of cells may be SCells in the set of cells. Each configured group of cells may be defined by RRC configuration. For example, referring to FIG. 8, the network entity (SpCell 804) may transmit, at 810, to the UE 802, L1 or L2 signaling indicating an activation/deactivation command for one or more configured cells in the set of cells and carrying information about activation, deactivation, or update of the SpCell, or update of a group of cells with SpCell.

At 1006, the network entity may communicate with the UE via one or more activated cells in the set of cells based on the L1 or L2 signaling. For example, referring to FIG. 8, the network entity (SpCell 804) may communicate, at 812 with the UE 802 via one or more activated cells in the set of cells based on the L1 or L2 signaling.

In some aspects, the L1 or L2 signaling may be transmitted through a MAC-CE or DCI. For example, referring to FIG. 8, when the network entity (SpCell 804) transmits, at 810, to the UE 802, the L1 or L2 signaling, the L1 or L2 signaling may be transmitted through a MAC-CE or DCI.

In some aspects, the information about the activation or the deactivation of the SpCell may indicate a current SpCell is unchanged. In some aspects, the information about the activation or the deactivation of the SpCell may activate a different SpCell. For example, referring to FIG. 8, in one example, the L1 or L2 signaling the network entity (SpCell 804) transmits, at 810, may carry information that indicates a current SpCell 804 is unchanged. In another example, the L1 or L2 signaling the network entity (SpCell 804) transmits, at 810, may carry information that activates a different SpCell than the SpCell 804.

In some aspects, the L1 or L2 signaling may include one or more of: an ID pointer to a cell ID of a cell in the set of cells being activated or deactivated; ID information corresponding to the cell ID; a field indicating whether the cell is activated as a new SpCell; a configuration pointer to an SpCell configuration of multiple previously configured SpCell configurations; SpCell configuration information corresponding to the SpCell configuration of the multiple previously configured SpCell configurations; a TCI state to activate for each activated cell in the set of cells; an RS for beam refinement; and an RS ID to use for L1 reporting of the cells being deactivated in the set of cells. In one example, referring to FIGS. 7A and 7B, the ID information corresponding to a cell ID may be an ID bit (C₁, C₂, C₃, . . . C₃₁ in FIGS. 7A and 7B) in a bit map 702, 752. The SpCell configuration information may be a bit (e.g., an SpCell configuration ID 710A, 710B, 760) in the bit map corresponding to the SpCell configuration of the multiple previously configured SpCell configurations. In some aspects, the L1 or L2 signaling may be transmitted through a message in the MAC-CE, and the message may include one or more of: activation information indicating activated cells and deactivated cells in the set of cells, a TRS ID for each of the activated cells that were deactivated, a cell ID for a new SpCell in the set of cells, and an SpCell configuration ID for an SpCell configuration of multiple SpCell configurations for the new SpCell. For example, referring to FIGS. 7A, 7B, 8, the activation information may be a bitmap 702, 752 indicating activated cells and deactivated cells in the set of cells. The message the network entity (SpCell 804) transmits, at 810, may include one or more of: a bitmap 702, 752 indicating activated cells and deactivated cells in the set of cells, a TRS ID 704A, 704B, 754A, 754B for each of the activated cells that were deactivated, a cell ID 708A, 708B for a new SpCell in the set of cells, and an SpCell configuration ID 710A, 710B, 760 for an SpCell configuration of multiple SpCell configurations for the new SpCell.

In some aspects, the message may include a number of octets corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE. For example, referring to FIGS. 7A, 7B, and 8, the network entity (SpCell 804) may transmit to the UE 802, at 810, the L1 or L2 signaling through a message 700, 750 in the MAC-CE, and the message 700, 750 may include a number of octets Oct1, Oct2, Oct3, . . . corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE 802.

In some aspects, the message may include the cell ID for the new SpCell in the set of cells and the SpCell configuration ID, and the cell ID and the SpCell configuration ID may occupy a separate octet with zero or more reserved bits. For example, referring to FIGS. 7A and 7B, the message 700, 750 may include the cell ID 708A, 708B for the new SpCell in the set of cells and the SpCell configuration ID 710A, 710B, 760, and the cell ID 708A, 708B and the SpCell configuration ID 710A, 710B, 760 may occupy a separate octet with zero or more reserved bits 712, 762.

In some aspects, a first octet of the number of octets may include a reserved bit, and the reserved bit may be configured to indicate one or more of: whether the MAC-CE carries an SpCell update; and a new status of a current SpCell in the set of cells. For example, referring to FIGS. 7A and 7B, the first octet Oct1 of the number of octets may include a reserved bit R 714, 764. The reserved bit R 714, 764 may be configured to indicate one or more of: whether the MAC-CE carries an SpCell update; and a new status of a current SpCell in the set of cells.

In some aspects, an octet corresponding to the TRS ID may include an 8-bit TRS ID pointing to an SCell configuration for the SCells activated by the L1 or L2 signaling. For example, referring to FIGS. 7A and 8, an octet corresponding the TRS ID may include an 8-bit TRS ID 704A, 704B pointing to an SCell configuration for the SCells activated by the L1 or L2 signaling the network entity (SpCell 804) transmits at 810.

In some aspects, an octet corresponding to the TRS ID may include a 7-bit TRS ID and a one-bit status field indicating whether there is an SpCell update. For example, referring to FIG. 7B, an octet corresponding to the TRS ID may include a 7-bit TRS ID 754A, 754B and a one-bit status field S 756 indicating whether there is an SpCell update.

In some aspects, when the one-bit status field is 0, the 7-bit TRS ID may point to an SCell configuration for the SCells activated by the L1 or L2 signaling. When the one-bit status field is 1, the 7-bit TRS ID may point to the SpCell configuration for the SpCell activated by the L1 or L2 signaling. For example, referring to FIGS. 7B and 8, when the one-bit status field S 756 is 0, the 7-bit TRS ID 754A may point to an SCell configuration for the SCells activated by the L1 or L2 signaling the network entity (SpCell 804) transmits at 810. When the one-bit status field S 756 is 1, the 7-bit TRS ID 754A may point to the SpCell configuration for the SpCell activated by the L1 or L2 signaling the network entity (SpCell 804) transmits at 810.

In some aspects, the one-bit status field may be 1, and the message may further include one or more additional octets for additional information for the SpCell. In some aspects, the one or more additional octets may include the SpCell configuration ID for the SpCell configuration of the multiple SpCell configurations. For example, referring to FIG. 7B, the one-bit status field S may be 1, and the message 750 may further include one or more additional octets OctM for additional information for the SpCell. The one or more additional octets OctM may include the SpCell configuration ID 760 for the SpCell configuration of the multiple SpCell configurations.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to receive, from a network entity, a configuration for L1 or L2 mobility cell for a set of cells that are able to be activated or deactivated for data or control transmission using L1 or L2 signaling. The configuration may include at least one cell that supports L1 or L2 activation as an SpCell. The component 198 may be further configured to receive, from the network entity, L1 or L2 signaling for one or more configured cells or one or more configured groups of cells in the set of cells carrying information about activation, deactivation, or update of the SpCell, or update of a group of cells with SpCell; and communicate via one or more activated cells in the set of cells based on the L1 or L2 signaling. The component 198 may be further configured to perform any of the aspects described in connection with the flowchart in FIG. 9 and/or performed by the UE 802 in FIG. 8. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving, from a network entity, a configuration for L1 or L2 mobility cell for a set of cells that are able to be activated or deactivated for data or control transmission using L1 or L2 signaling. The configuration may include at least one cell that supports L1 or L2 activation as an SpCell. The apparatus 1104 may further include means for receiving, from the network entity, L1 or L2 signaling for one or more configured cells or one or more configured groups of cells in the set of cells carrying information about activation, deactivation, or update of the SpCell, or update of a group of cells with SpCell, and means for communicating via one or more activated cells in the set of cells based on the L1 or L2 signaling. The apparatus 1104 may further include means for performing any of the aspects described in connection with the flowchart in FIG. 9, and/or aspects performed by the UE 802 in FIG. 8. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

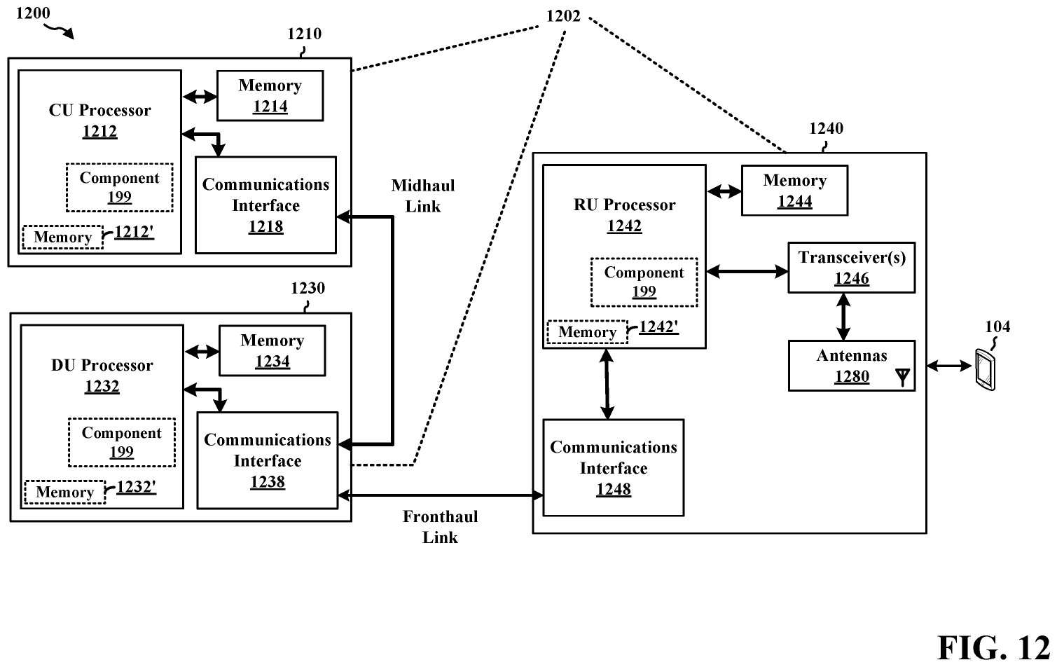

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, to a UE, a configuration for L1 or L2 mobility cell for a set of cells that are able to be activated or deactivated for data or control transmission using L1 or L2 signaling. The configuration may include at least one cell that supports L1 or L2 activation as an SpCell. The component 199 may be further configured to transmit, to the UE, L1 or L2 signaling indicating an activation/deactivation command for one or more configured cells or one or more configured groups of cells in the set of cells carrying information about activation, deactivation, or update of the SpCell, or update of a group of cells with SpCell; and communicate with the UE via one or more activated cells in the set of cells based on the L1 or L2 signaling. The component 199 may be further configured to perform any of the aspects described in connection with the flowchart in FIG. 10, and/or performed by the SpCell 804 in FIG. 8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for transmitting, to a UE, a configuration for L1 or L2 mobility cell for a set of cells that are able to be activated or deactivated for data or control transmission using L1 or L2 signaling. The configuration may include at least one cell that supports L1 or L2 activation as an SpCell. The network entity 1202 may further include means for transmitting, to the UE, L1 or L2 signaling for one or more configured cells or one or more configured groups of cells in the set of cells carrying information about activation, deactivation, or update of the SpCell, or update of a group of cells with SpCell, and means for communicating with the UE via one or more activated cells in the set of cells based on the L1 or L2 signaling. The network entity 1202 may further include means for performing any of the aspects described in connection with the flowchart in FIG. 10, and/or aspects performed by the SpCell 804 in FIG. 8. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a configuration for L1 or L2 mobility cell for a set of cells that are able to be activated or deactivated for data or control transmission using L1 or L2 signaling. The configuration may include at least one cell that supports L1 or L2 activation as an SpCell. The method further includes receiving, from the network entity, L1 or L2 signaling for one or more configured cells or one or more configured groups of cells in the set of cells carrying information about activation, deactivation, or update of the SpCell, or update of a group of cells with SpCell; and communicating via one or more activated cells in the set of cells based on the L1 or L2 signaling. The method enables joint cell activation/deactivation in SCell and PCell to facilitate fast and efficient L1/L2 mobility. Thus, it improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a configuration for layer 1 (L1) or layer 2 (L2) mobility cell for a set of cells that are able to be activated or deactivated for data or control transmission using L1 or L2 signaling. The configuration includes at least one cell that supports L1 or L2 activation as a special cell (SpCell). The method further includes receiving, from the network entity, L1 or L2 signaling for one or more configured cells or one or more configured groups of cells in the set of cells carrying information about activation, deactivation, or update of the SpCell, or update of a group of cells with SpCell; and communicating via one or more activated cells in the set of cells based on the L1 or L2 signaling.

Aspect 2 is the method of aspect 1, where the configured cells or the configured groups of cells in the set of cells are SCells in the set of cells, and the L1 or L2 signaling is received through a medium access control-control element (MAC-CE) or downlink control information (DCI).

Aspect 3 is the method of any of aspects 1 or 2, where the information about the activation or the deactivation of the SpCell indicates a current SpCell is unchanged.

Aspect 4 is the method of any of aspects 1 or 2, where the information about the activation or the deactivation of the SpCell activates a different SpCell.

Aspect 5 is the method of any of aspects 1 to 4, wherein the L1 or L2 signaling includes one or more of: an ID pointer to a cell ID of a cell in the set of cells being activated or deactivated; ID information corresponding to the cell ID; a field indicating whether the cell is activated as a new SpCell; a configuration pointer to an SpCell configuration of multiple previously configured SpCell configurations; SpCell configuration information corresponding to the SpCell configuration of the multiple previously configured SpCell configurations; a transmission configuration indicator (TCI) state to activate for each activated cell in the set of cells; a reference signal (RS) for beam refinement; and an RS ID to use for L1 reporting of the cells being deactivated in the set of cells.

Aspect 6 is the method of aspect 2, wherein the L1 or L2 signaling is received through a message in the MAC-CE, and the message includes one or more of: activation information indicating activated cells and deactivated cells in the set of cells, a tracing reference signal (TRS) ID for each of the activated cells that were deactivated, a cell ID for a new SpCell in the set of cells, and a SpCell configuration ID for an SpCell configuration of multiple SpCell configurations for the new SpCell.

Aspect 7 is the method of aspect 6, where the message includes a number of octets corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE.

Aspect 8 is the method of aspect 7, where the message includes the cell ID for the new SpCell in the set of cells and the SpCell configuration ID, and the cell ID and the SpCell configuration ID occupy a separate octet with zero or more reserved bits.

Aspect 9 is the method of aspect 7, where a first octet of the number of octets includes a reserved bit, and the reserved bit is configured to indicate one or more of: whether the MAC-CE carries an SpCell update; and a new status of a current SpCell in the set of cells.

Aspect 10 is the method of aspect 7, where an octet corresponding to the TRS ID includes an 8-bit TRS ID pointing to an SCell configuration for the SCells activated by the L1 or L2 signaling.

Aspect 11 is the method of aspect 7, where an octet corresponding to the TRS ID includes a 7-bit TRS ID and a one-bit status field indicating whether there is an SpCell update.

Aspect 12 is the method of aspect 11, where, when the one-bit status field is 0, the 7-bit TRS ID points to an SCell configuration for the SCells activated by the L1 or L2 signaling, and, when the one-bit status field is 1, the 7-bit TRS ID points to the SpCell configuration for the SpCell activated by the L1 or L2 signaling.

Aspect 13 is the method of aspect 12, where the one-bit status field is 1, and the message further includes one or more additional octets for additional information for the SpCell.

Aspect 14 is the method of aspect 13, where the one or more additional octets include the SpCell configuration ID for the SpCell configuration of the multiple SpCell configurations.

Aspect 15 is an apparatus for wireless communication at a UE, including: a memory; and at least one processor coupled to the memory and, based at least in part on information stored in the memory, the at least one processor is configured to perform the method of any of aspects 1-14.

Aspect 16 is the apparatus of aspect 15, further including at least one of a transceiver or an antenna coupled to the at least one processor and configured to receive the configuration for L1 or L2 mobility cell and to receive the L1 or L2 signaling.

Aspect 17 is an apparatus for wireless communication including means for implementing the method of any of aspects 1-14.

Aspect 18 is a computer-readable medium (e.g., a non-transitory computer-readable medium) storing computer executable code, where the code when executed by a processor causes the processor to implement the method of any of aspects 1-14.

Aspect 19 is a method of wireless communication at a network entity. The method includes transmit, to a UE, a configuration for L1 or L2 mobility cell for a set of cells that are able to be activated or deactivated for data or control transmission using L1 or L2 signaling. The configuration includes at least one cell that supports L1 or L2 activation as an SpCell. The method further includes transmitting, to the UE, L1 or L2 signaling for one or more configured cells or one or more configured groups of cells in the set of cells carrying information about activation, deactivation, or update of the SpCell, or update of a group of cells with SpCell; and communicating with the UE via one or more activated cells in the set of cells based on the L1 or L2 signaling.

Aspect 20 is the method of aspect 19, where the configured cells or the configured groups of cells in the set of cells are SCells in the set of cells, the L1 or L2 signaling is transmitted in a MAC-CE or DCI.

Aspect 21 is the method of any of aspects 19 to 20, where the information about the activation or the deactivation of the SpCell indicates a current SpCell is unchanged.

Aspect 22 is the method of any of aspects 19 to 20, where the information about the activation or the deactivation of the SpCell activates a different SpCell.

Aspect 23 is the method of any of aspects 20 to 22, where the L1 or L2 signaling includes one or more of: an ID pointer to a cell ID of a cell in the set of cells being activated or deactivated; ID information corresponding to the cell ID; a field indicating whether the cell is activated as a new SpCell; a configuration pointer to an SpCell configuration of multiple previously configured SpCell configurations; SpCell configuration information corresponding to the SpCell configuration of the multiple previously configured SpCell configurations; a TCI state to activate for each activated cell in the set of cells; an RS for beam refinement; and an RS ID to use for L1 reporting of the cells in the set of cells being deactivated.

Aspect 24 is the method of aspect 20, where the L1 or L2 signaling is transmitted through a message in the MAC-CE, and the message includes one or more of: activation information indicating activated cells and deactivated cells in the set of cells, a TRS ID for each of the activated cells that were deactivated, a cell ID for a new SpCell in the set of cells, and a SpCell configuration ID for an SpCell configuration of multiple SpCell configurations for the new SpCell.

Aspect 25 is the method of aspect 24, where the message includes a number of octets corresponding to a first maximum number of cells configured for the data or the control using the L1 or L2 signaling, an overall number of cells configured for the data or the control using the L1 or L2 signaling, or a second maximum number of cells that can be configured for the data or control transmission using the L1 or L2 signaling for the UE.

Aspect 26 is the method of aspect 25, where the message includes the cell ID for the new SpCell in the set of cells and the SpCell configuration ID, and the cell ID and the SpCell configuration ID occupy a separate octet with zero or more reserved bits.

Aspect 27 is the method of aspect 25, where a first octet of the number of octets includes a reserved bit, and the reserve bit is configured to indicate one or more of: whether the MAC-CE carries an SpCell update; and a new status of a current SpCell in the set of cells.

Aspect 28 is the method of aspect 25, where an octet corresponding to the TRS ID includes an 8-bit TRS ID pointing to an SCell configuration for the SCells activated by the L1 or L2 signaling.

Aspect 29 is the method of aspect 25, where an octet corresponding to the TRS ID includes a 7-bit TRS ID and a one-bit status field indicating whether there is an SpCell update.

Aspect 30 is the method of aspect 29, where, when the one-bit status field is 0, the 7-bit TRS ID points to an SCell configuration for the SCells activated by the L1 or L2 signaling, and, when the one-bit status field is 1, the 7-bit TRS ID points to the SpCell configuration for the SpCell activated by the L1 or L2 signaling.

Aspect 31 is the method of aspect 30, where the one-bit status field is 1, and the message further includes one or more additional octets for additional information for the SpCell.

Aspect 32 is the method of aspect 31, where the one or more additional octets include the SpCell configuration ID for the SpCell configuration of the multiple SpCell configurations.

Aspect 33 is an apparatus for wireless communication at a network entity, including: a memory; and at least one processor coupled to the memory and, based at least in part on information stored in the memory, the at least one processor is configured to perform the method of any of aspects 19-32.

Aspect 34 is the apparatus of aspect 33, further including at least one of a transceiver or an antenna coupled to the at least one processor and configured to transmit the configuration for the L1 or L2 mobility cell and to transmit the L1 or L2 signaling.

Aspect 35 is an apparatus for wireless communication including means for implementing the method of any of aspects 19-32.

Aspect 36 is a computer-readable medium (e.g., a non-transitory computer-readable medium) storing computer executable code, where the code when executed by a processor causes the processor to implement the method of any of aspects 19-32.

What is claimed is:

1. An apparatus for wireless communication at a user equipment (UE), comprising:
memory; and
at least one processor coupled to the memory and configured to:
receive, from a network entity, a configuration for layer 1 (L1) or layer 2 (L2) mobility cell for a set of cells that are able to be activated or deactivated for data or control transmission using L1 or L2 signaling, the configuration including at least one cell that supports L1 or L2 activation as a special cell (SpCell);
receive, from the network entity, L1 or L2 signaling for one or more configured cells or one or more configured groups of cells in the set of cells, the L1 or L2 signaling carrying information about activation, deactivation, or update of the SpCell, or update of a group of cells with SpCell; and
communicate via one or more activated cells in the set of cells based on the L1 or L2 signaling.

2. The apparatus of claim 1, wherein the one or more configured cells or the one or more configured groups of cells in the set of cells are secondary cells (SCells) in the set of cells, and the L1 or L2 signaling is received through a medium access control-control element (MAC-CE) or downlink control information (DCI).

3. The apparatus of claim 2, wherein the information about the activation or the deactivation of the SpCell indicates a current SpCell is unchanged.

4. The apparatus of claim 2, wherein the information about the activation or the deactivation of the SpCell activates a different SpCell.

5. The apparatus of claim 2, further comprising:
at least one transceiver coupled to the at least one processor and configured to receive the L1 or L2 signaling, wherein the L1 or L2 signaling comprises one or more of:
an ID pointer to a cell ID of a cell in the set of cells being activated or deactivated;
ID information corresponding to the cell ID;
a field indicating whether the cell is activated as a new SpCell;
a configuration pointer to an SpCell configuration of multiple previously configured SpCell configurations;
SpCell configuration information corresponding to the SpCell configuration of the multiple previously configured SpCell configurations;
a transmission configuration indicator (TCI) state to activate for each activated cell in the set of cells;
a reference signal (RS) for beam refinement; and
an RS ID to use for L1 reporting of the cells being deactivated in the set of cells.

6. The apparatus of claim 2, wherein the L1 or L2 signaling is received through a message in the MAC-CE, and the message comprises one or more of:
activation information indicating activated cells and deactivated cells in the set of cells,
a tracing reference signal (TRS) ID for each of the activated cells that were deactivated,
a cell ID for a new SpCell in the set of cells, and
an SpCell configuration ID for an SpCell configuration of multiple SpCell configurations for the new SpCell.

7. The apparatus of claim 6, wherein the message includes a number of octets corresponding to a first maximum number of cells configured for the data or the control using the L1 or L2 signaling, an overall number of cells configured for the data or the control using the L1 or L2 signaling, or a second maximum number of cells that can be configured for the data or the control using the L1 or L2 signaling for the UE.

8. The apparatus of claim 7, wherein the message comprises the cell ID for the new SpCell in the set of cells and the SpCell configuration ID, wherein the cell ID and the SpCell configuration ID occupy a separate octet with zero or more reserved bits.

9. The apparatus of claim 7, wherein a first octet of the number of octets comprises a reserved bit, and the reserved bit is configured to indicate one or more of:
whether the MAC-CE carries an SpCell update; and
a new status of a current SpCell in the set of cells.

10. The apparatus of claim 7, wherein an octet corresponding to the TRS ID includes an 8-bit TRS ID pointing to an SCell configuration for the SCells activated by the L1 or L2 signaling.

11. The apparatus of claim 7, wherein an octet corresponding to the TRS ID includes a 7-bit TRS ID and a one-bit status field indicating whether there is an SpCell update.

12. The apparatus of claim 11, wherein, when the one-bit status field is 0, the 7-bit TRS ID points to an SCell configuration for the SCells activated by the L1 or L2 signaling, and, when the one-bit status field is 1, the 7-bit TRS ID points to the SpCell configuration for the SpCell activated by the L1 or L2 signaling.

13. The apparatus of claim 12, wherein the one-bit status field is 1, and the message further includes one or more additional octets for additional information for the SpCell.

14. The apparatus of claim 13, wherein the one or more additional octets include the SpCell configuration ID for the SpCell configuration of the multiple SpCell configurations.

15. An apparatus for wireless communication at a network entity, comprising:
memory; and
at least one processor coupled to the memory and configured to:
transmit, to a user equipment (UE), a configuration for layer 1 (L1) or layer 2 (L2) mobility cell for a set of cells that are able to be activated or deactivated for data or control transmission using L1 or L2 signaling, the configuration including at least one cell that supports L1 or L2 activation as a special cell (SpCell);
transmit, to the UE, L1 or L2 signaling for one or more configured cells or one or more configured groups of cells in the set of cells, the L1 or L2 signaling carrying information about activation, deactivation, or update of the SpCell, or update of a group of cells with SpCell; and
communicate with the UE via one or more activated cells in the set of cells based on the L1 or L2 signaling.

16. The apparatus of claim 15, wherein the one or more configured cells or the one or more configured groups of cells in the set of cells are secondary cells (SCells) in the set of cells, and the L1 or L2 signaling is transmitted in a medium access control-control element (MAC-CE) or downlink control information (DCI).

17. The apparatus of claim 16, wherein the information about the activation or the deactivation of the SpCell indicates a current SpCell is unchanged.

18. The apparatus of claim 16, wherein the information about the activation or the deactivation of the SpCell activates a different SpCell.

19. The apparatus of claim 16, wherein the L1 or L2 signaling comprises one or more of:
an ID pointer to a cell ID of a cell in the set of cells being activated or deactivated;
ID information corresponding to the cell ID;
a field indicating whether the cell is activated as a new SpCell;
a configuration pointer to an SpCell configuration of multiple previously configured SpCell configurations;
SpCell configuration information corresponding to the SpCell configuration of the multiple previously configured SpCell configurations;
a transmission configuration indicator (TCI) state to activate for each activated cell in the set of cells;
a reference signal (RS) for beam refinement; and
an RS ID to use for L1 reporting of the cells in the set of cells being deactivated.

20. The apparatus of claim 16, wherein the L1 or L2 signaling is transmitted through a message in the MAC-CE, and the message comprises one or more of:
activation information indicating activated cells and deactivated cells in the set of cells,
a tracing reference signal (TRS) ID for each of the activated cells that were deactivated,
a cell ID for a new SpCell in the set of cells, and
an SpCell configuration ID for an SpCell configuration of multiple SpCell configurations for the new SpCell.

21. The apparatus of claim 20, wherein the message includes a number of octets corresponding to a first maximum number of cells configured for the data or the control using the L1 or L2 signaling, an overall number of cells configured for the data or the control using the L1 or L2 signaling, or a second maximum number of cells that can be configured for the data or control transmission using the L1 or L2 signaling for the UE.

22. The apparatus of claim 21, wherein the message comprises the cell ID for the new SpCell in the set of cells and the SpCell configuration ID, wherein the cell ID and the SpCell configuration ID occupy a separate octet with zero or more reserved bits.

23. The apparatus of claim 21, wherein a first octet of the number of octets comprises a reserved bit, and the reserve bit is configured to indicate one or more of:
whether the MAC-CE carries an SpCell update; and
a new status of a current SpCell in the set of cells.

24. The apparatus of claim 21, wherein an octet corresponding to the TRS ID includes an 8-bit TRS ID pointing to an SCell configuration for the SCells activated by the L1 or L2 signaling.

25. The apparatus of claim 21, wherein an octet corresponding to the TRS ID includes a 7-bit TRS ID and a one-bit status field indicating whether there is an SpCell update.

26. The apparatus of claim 25, wherein, when the one-bit status field is 0, the 7-bit TRS ID points to an SCell configuration for the SCells activated by the L1 or L2 signaling, and, when the one-bit status field is 1, the 7-bit TRS ID points to the SpCell configuration for the SpCell activated by the L1 or L2 signaling.

27. The apparatus of claim 26, wherein the one-bit status field is 1, and the message further includes one or more additional octets for additional information for the SpCell.

28. The apparatus of claim 27, wherein the one or more additional octets include the SpCell configuration ID for the SpCell configuration of the multiple SpCell configurations.

29. A method for wireless communication at a user equipment (UE), comprising:
receiving, from a network entity, a configuration for layer 1 (L1) or layer 2 (L2) mobility cell for a set of cells that are able to be activated or deactivated for data or control transmission using L1 or L2 signaling, the configuration including at least one cell that supports L1 or L2 activation as a special cell (SpCell);
receiving, from the network entity, L1 or L2 signaling for one or more configured cells or one or more configured groups of cells in the set of cells, the L1 or L2 signaling carrying information about activation, deactivation, or update of the SpCell, or update of a group of cells with SpCell; and
communicating via one or more activated cells in the set of cells based on the L1 or L2 signaling.

30. A method for wireless communication at a network entity, comprising:
transmitting, to a user equipment (UE), a configuration for layer 1 (L1) or layer 2 (L2) mobility cell for a set of cells that are able to be activated or deactivated for data or control transmission using L1 or L2 signaling, the configuration including at least one cell that supports L1 or L2 activation as a special cell (SpCell);
transmitting, to the UE, L1 or L2 signaling for one or more configured cells or one or more configured groups of cells in the set of cells, the L1 or L2 signaling carrying information about activation, deactivation, or update of the SpCell, or update of a group of cells with SpCell; and
communicating with the UE via one or more activated cells in the set of cells based on the L1 or L2 signaling.
